(19) United States
(12) Patent Application Publication
(10) Pub. No.: US 2026/0055309 A1
(43) Pub. Date: Feb. 26, 2026

(54) GRAPHENE-ENHANCED THERMAL INTERFACE MATERIAL AND METHOD FOR MANUFACTURING THE MATERIAL

(71) Applicant: SHT Smart High-Tech AB, GÖTEBORG (SE)

(72) Inventor: Johan Liu, VÄSTRA FRÖLUNDA (SE)

(21) Appl. No.: 19/119,998

(22) PCT Filed: Oct. 3, 2023
(86) PCT No.: PCT/SE2023/050983

§ 371 Date: Apr. 10, 2025

(30) Foreign Application Priority Data
Oct. 11, 2022 (SE) 2251191-9

(51) Int. Cl. C09K 5/14

(52) U.S. Cl. CPC C09K 5/14

(57) ABSTRACT

Method for manufacturing a thermal interface film, the method comprising: providing a template comprising a plurality of openings through the template; arranging graphene fibers through the openings; attaching a support plate on at least one side of the template such that the graphene fibers are attached to the support plate; removing the template to expose the graphene fibers; infiltrating the graphene fibers with a polymer material to form a block of polymer infiltrated graphene fibers; and cutting the block of polymer infiltrated graphene fibers along a direction perpendicular to the extension of the graphene fibers to form a thermal interface film.

### FIELD OF THE INVENTION

The present invention relates to the field of microelectronics packaging, and especially to thermal interface materials in which heat dissipation is a crucial issue.

### BACKGROUND OF THE INVENTION

With the continuous development of modern electronics devices and systems, their increasing power densities have also caused higher operating temperatures. Therefore, effective thermal management is becoming extremely crucial for removing the large amount of heat required for ensuring high performance and long lifetime reliability. Thermal conductivity of traditional thermal interface materials (TIMs), a very important element for heat dissipation, is often less than max 10 W/mK, usually around 4 or 5 W/mK in vertical directions. Great efforts have hence been made to develop high performance TIMs based on carbon materials (e.g., graphite nano-platelets, carbon nanotubes and carbon fibers) in order to solve this problem.

However, there is still room for further improvement of graphene-enhanced thermal interface materials.

### SUMMARY

In view of above-mentioned and other drawbacks of the prior art, it is an object of the present invention to provide an improved high thermal conductivity interface material and a method for manufacturing the material.

According to a first aspect of the invention, there is provided a method for manufacturing a thermal interface film, the method comprising: providing a template comprising a plurality of openings through the template; arranging graphene fibers through the openings; attaching a support plate on at least one side of the template such that the graphene fibers are attached to the support plate; removing the template to expose the graphene fibers; infiltrating the graphene fibers with a polymer material to form a block of polymer infiltrated graphene fibers; and cutting the block of polymer infiltrated graphene fibers along a direction perpendicular to the extension of the graphene fibers to form a thermal interface film.

In the present context, the template can be seen as a support structure for forming a plurality of graphene fibers, where the support structure is subsequently removed.

Graphene fibers have been shown to have very high thermal conductivity, in excess of 1000-2000 W/mK, and the present invention aims to implement graphene fibers in a polymer material to form a thermal interface material having a high thermal conductivity in the vertical direction. That the material is referred to as a film should be interpreted to mean that the extension in an xy-plane is often substantially larger than the thickness of the film. Accordingly, a vertical direction is seen as the direction perpendicular to the xy-plane of the film, i.e. the z-direction. The described thermal interface film can be formed as pads or patches of appropriate size to be arranged for example between a heat-generating electrical component and a cooling element.

In particular, the present invention is based on the realization that a thermal interface film having any suitable configuration and arrangement of graphene fibers can be easily achieved by using a template which is subsequently removed. Accordingly, the graphene-based film can be tailored to suit different applications simply by modifying the configuration of the template. Moreover, the described thermal interface film can greatly improve thermal performance in vertical directions while maintaining mechanical performance in in-plane directions of the thermal interface film.

The thermal interface film resulting from the described method can be referred to as a graphene-based or graphene-enhanced film where the improved thermal conductivity in the vertical direction is achieved by means of the graphene fibers.

According to one embodiment of the invention, the method further comprises planarizing a top surface of the block of polymer infiltrated graphene fibers before cutting the block in order to improve the smoothness of the surface of the film, thus providing improved heat transfer.

According to one embodiment of the invention, removing the template comprises etching away the template. The template may be made from a plastic material such as polyethene or polypropylene, or it may be made from for example aluminum oxide. By etching away the template, the graphene fibers will be exposed and remain in the shape and configuration according to the through-openings of the template.

According to one embodiment of the invention, the support plate is made from a metal such as copper or steel. Moreover, in an embodiment where the template is etched away, the bottom plate is made from a material which is resistant to the etch technique used to remove the template such that the bottom plate remains after etching.

According to one embodiment of the invention, attaching the support plate comprises gluing the plate to the template and to the graphene fibers, for example by using an epoxy-based glue. The support plate thereby forms a bottom plate from which the graphene fibers will protrude after removal of the template. Aside from an epoxy based glue, other materials such as acrylics and urethane based adhesives can also be used. Epoxy offers strength and good adhesion to many substrates while acrylics can offer good elasticity, and urethane based adhesives can be used for most bonding surfaces. Accordingly, different adhesives have different properties and different advantages making it possible to select the adhesive most suitable for a given application.

According to one embodiment of the invention the method further comprises arranging a mould around the template, the mould comprising solid walls to contain the polymer material. The mould may be a box-shaped object having the same shape as the template arranged to contain the polymer material during infiltration of the graphene fibers. Moreover, the mould may be attached to the bottom plate to form a closed seal preventing a liquid polymer material from leaking. It is also possible to provide a mould which comprises the support plate, i.e. where attaching a support plate simultaneously comprises arranging the mould around the template.

According to one embodiment of the invention, arranging the graphene fibers through the openings comprises stitching of the fibers. Graphene fibers can be provided on a roll similarly to a thread in which case a stitching machine can be used to thread the fibre through the openings of the template. Using stitching provides a fast and readily available method of mass producing the described thermal interface film.

According to one embodiment of the invention, the method further comprises braiding and/or twisting the graphene fibers before arranging them in the openings. Thereby, both mechanical and thermal properties of the graphene fibers can be modified before arranging the fibers in the template. For example, stitching may require fibers which are both mechanically strong as well as flexible, which can be achieved by twisting and/or braiding the fibers in a similar manner as for ropes and steel-wires.

According to one embodiment of the invention, the method comprises attaching support plates on two opposing sides of the template. The two opposing support plates can thereby act to hold the graphene fibers in place once the template is removed.

According to a second aspect of the invention, there is provided thermal interface film comprising: a plurality of area portions consisting of polymer-infiltrated graphene fibers, wherein the extension of the graphene fibers are in a direction perpendicular to the plane of the film; and wherein the plurality of area portions of polymer-infiltrated graphene are surrounded the fibers comprise a polymer.

The thermal interface film manufactured according to the above described method may be configured to have a thermal conductivity in a direction perpendicular to the plane of the film in the range of 10 W/mK to 200 W/mK. Thermal resistance and thereby thermal conductivity can be determined using a method according to ASTM 5470 standard.

According to one embodiment of the invention, the amount of graphene fibers in the thermal interface film is in the range of 5 vol % to 90 vol %.

According to an example embodiment, the polymer-infiltrated graphene fibers may comprise continuous graphene fibers reaching from a top surface of the thermal interface film to a bottom surface of the thermal interface film.

According to an example embodiment, the polymer-infiltrated graphene fibers may comprise braided graphene fibers.

According to an example embodiment, the polymer-infiltrated graphene fibers may comprise twisted graphene fibers.

According to an example embodiment, the polymer-infiltrated graphene fibers may comprise graphene fibers reinforced by graphene flakes.

Effects and features of the second aspect of the invention are analogous to the advantages discussed above in relation to the first aspect.

Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIGS. 1A-G schematically illustrate steps of a method according to an embodiment of the invention;

FIG. 2 is a flow chart outlining steps of a method according to an embodiment of the invention; and

FIGS. 3A-B schematically illustrate a feature a method according to an embodiment of the invention.

### DETAILED DESCRIPTION OF EXAMPLE EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person. Like reference characters refer to like elements throughout.

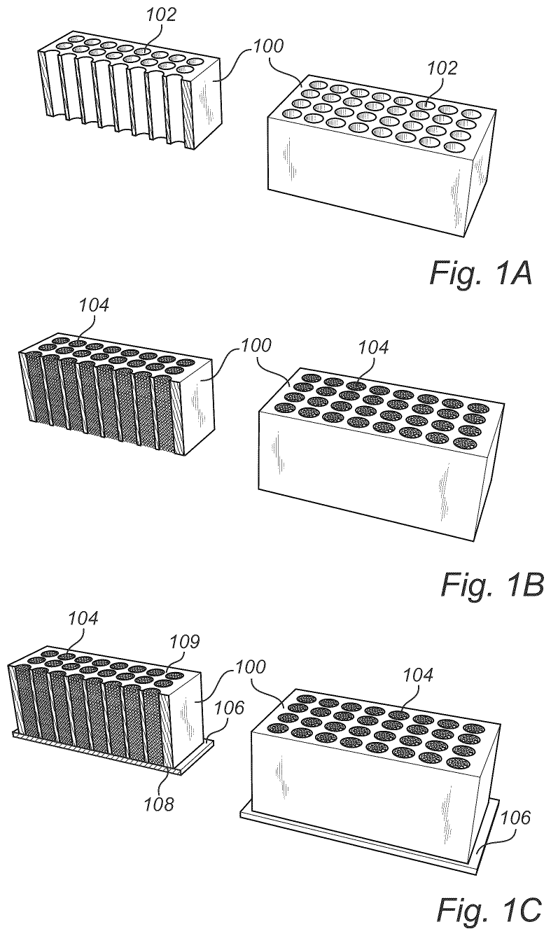

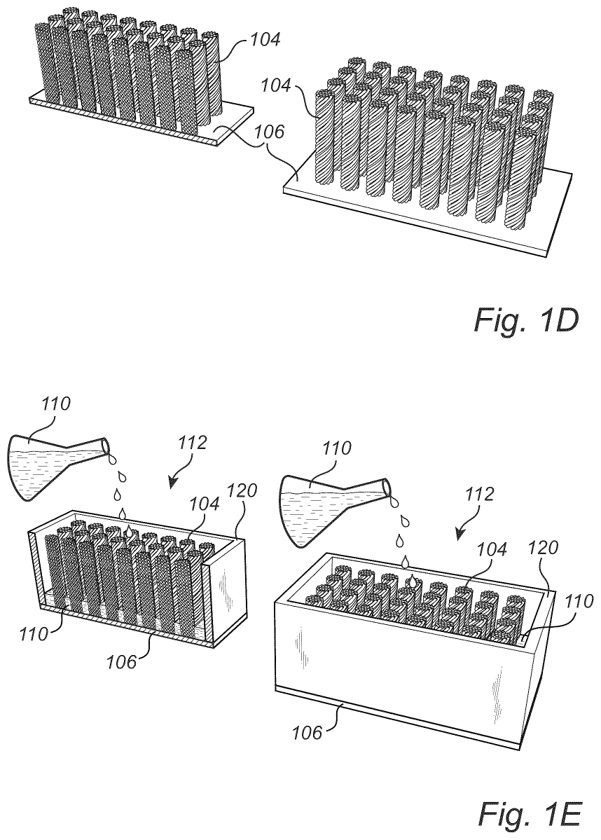

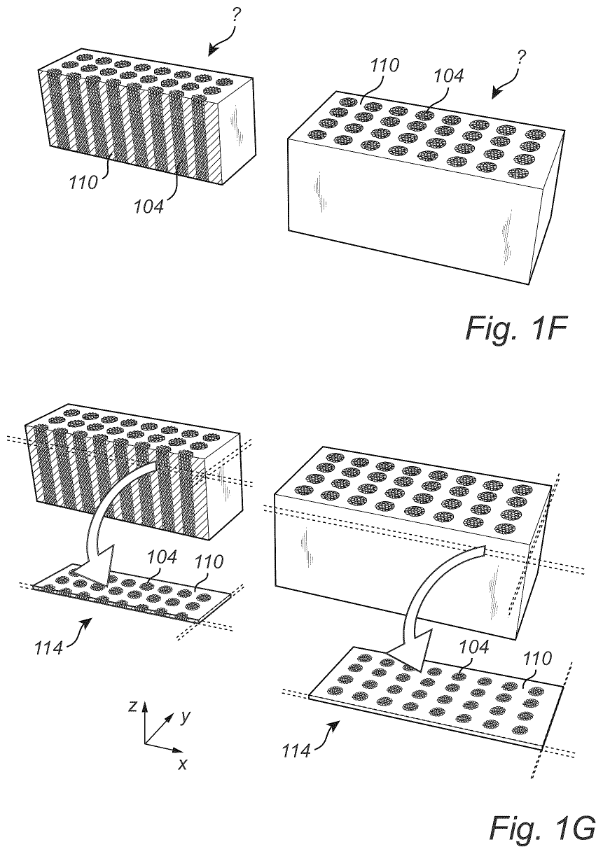

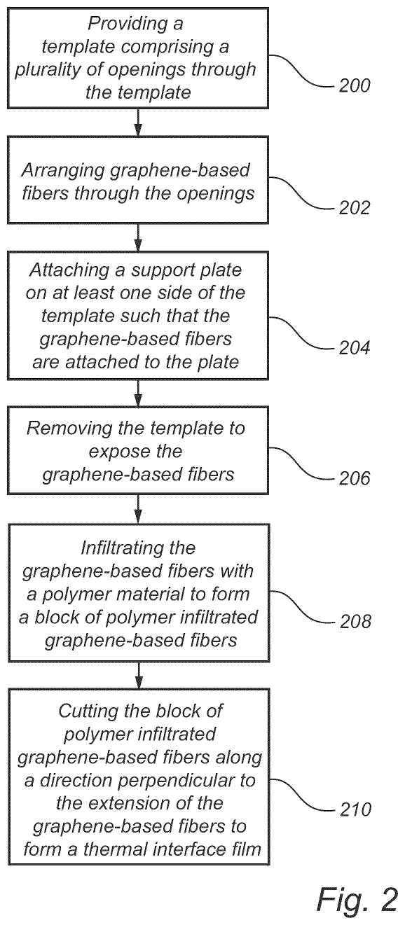

FIGS. 1A-F schematically illustrate a method of manufacturing a thermal interface film according to an embodiment of the invention and FIG. 1 will be described with further reference to FIG. 2 showing a flow chart outlining the steps of the method. In FIGS. 1A-F, the left hand figures are cross section views and eh right hand images are top views schematically illustrating steps of the manufacturing method.

First, a template 100 is provided 200 as illustrated in FIG. 1A. The template comprises a plurality of openings 102 running through the template. The template is thus a block of material comprising through-openings where the graphene fibers will be placed. Moreover, it should be noted that the images are not drawn to scale or proportion. The height of the template 100 as well as the dimensions and pitch of through-openings 102 can be selected to give a resulting thermal interface film having the desired properties. For example, the openings may have a diameter in the range of 5 μm to 5 mm and a depth of 1 mm to 20 cm.

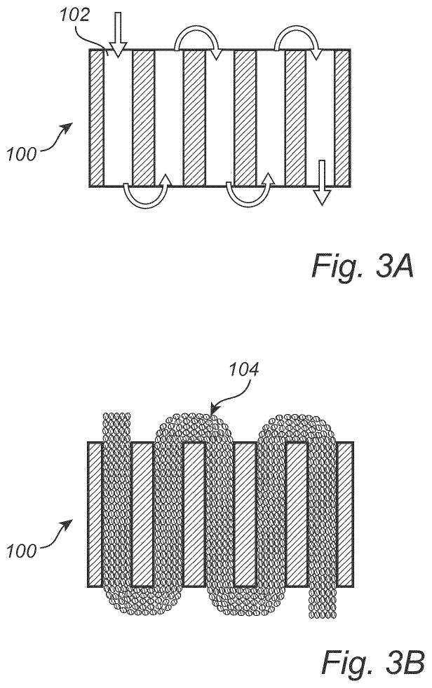

The next step comprises arranging 202 graphene fibers 104 through the openings 102. FIGS. 3A-B schematically illustrates an example embodiment where the graphene fibers 104 are stitched or weaved through the openings 102 of the template 100 using for example using a weaving machine, thereby facilitating fast and large-scale production. However, it is also possible to arrange strands of fiber in each of the openings manually or individually by means of a robot.

The manufacturing of graphene fibers is described elsewhere and only a general description will therefore be provided herein. The formation of graphene fibers starts with the manufacturing of graphene oxide (GO) flakes which are subsequently dispersed in water. From the mixture comprising GO-flakes, a graphene fiber is formed by means of electrospinning or melt spinning. The spun fibers may subsequently be twisted and/or braided to form the fibers or fiber bundles used in the present context. It is also possible to dip the fibers in a bath comprising graphene flakes to strengthen the fibers. The graphene fibers may be continuous graphene fibers having a length between 0.1 cm and 100 cm. The graphene fibers can thus be formed so that the diameter of the fiber correspond to the diameter of the opening 102 in the template 100.

Once the graphene fibers have been arranged in the openings as illustrated in FIG. 1B, a support plate 106 is attached 204 on at least one side 108 of the template such that the graphene fibers are attached to the support plate. In the embodiment illustrated in FIG. 1C, a support plate 106 is attached to a bottom surface 108 of the template 100. Optionally, a second support plate (not shown) could be attached to a top surface of the template 100. The support plate is attached to the template and to the graphene fibers by means of an epoxy-based glue.

The following step comprises removing 206 the template 100 to expose the graphene fibers 104 as illustrated in FIG. 1D. For example, a Polyester template can be etched away in aqueous NaOH. Chromic acid can be used to etch polypropylene. Aluminum oxide can be etched away using a solution based on phosphoric acid and nitric acid.

After removing the template 100, the graphene fibers 104 are left protruding from the bottom plate 106, and if a top plate is used, the fibers would be sandwiched between the top and bottom plates.

The next step comprises infiltrating 208 the graphene fibers 104 with a polymer material 110 to form a block 112 of polymer infiltrated graphene fibers. As illustrated in FIG. 1E, a mould 120 is arranged around the graphene fibers 104 to contain the polymer material 110 during infiltration. The mould 120 may comprise four sidewalls and it can be attached to the bottom plate 106. However, the mould 120 may also be box shaped so that the mould 120 comprises the bottom plate 106 being attached to the template 100. The mould 120 can thereby already be in place when the template 100 is removed. It is also possible to use a mould 120 having a lid to fully enclose the graphene fibers 104 during infiltration with the polymer material 110.

FIG. 1F schematically illustrates a block 112 of polymer infiltrated graphene fibers after removal of the mould 120 and of the bottom plate 106.

The final step illustrated in FIG. 1G comprises cutting 210 the block 112 of polymer infiltrated graphene fibers along a direction perpendicular to the extension of the graphene fibers to form a thermal interface film 114. The cutting is performed in the xy-plane as illustrated in FIG. 1F so that the resulting thermal interface film 114 comprises a plurality of area portions consisting of polymer-infiltrated graphene fibers 104, wherein the extension of the graphene fibers 104 are in a direction perpendicular to the plane of the film 114, i.e. in the z-direction. Moreover, the plurality of area portions of polymer-infiltrated graphene fibers 104 are surrounded by a polymer material 110. Cutting may by performed using any suitable cutting method such as sawing, plasma cutting, water milling, wire cutting etc.

The graphene content in the final thermal interface film 114 may be in the range of 5 vol % to 90 vol %. In an example embodiment, the graphene content in the final thermal interface film 114 is in the range of 30 vol % to 40 vol %.

The described method may also comprise planarizing the top surface and/or the bottom surface of the block 112 of polymer infiltrated graphene fibers prior to cutting the block 112.

Even though the invention has been described with reference to specific exemplifying embodiments thereof, many different alterations, modifications and the like will become apparent for those skilled in the art. Also, it should be noted that parts of the method may be omitted, interchanged or arranged in various ways, the method yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. Method for manufacturing a thermal interface film, the method comprising:
providing a template comprising a plurality of openings through the template;
arranging graphene fibers through the openings;
attaching a support plate on at least one side of the template such that the graphene fibers are attached to the support plate;
removing the template to expose the graphene fibers;
infiltrating the graphene fibers with a polymer material to form a block of polymer infiltrated graphene fibers; and
cutting the block of polymer infiltrated graphene fibers along a direction perpendicular to the extension of the graphene fibers to form a thermal interface film

2. The method according to claim 1, further comprises planarizing a top surface of the block of polymer infiltrated graphene fibers before cutting the block.

3. The method according to claim 1, wherein removing the template comprises etching away the template.

4. The method according to claim 1, wherein the template is made from a plastic material.

5. The method according to claim 1, wherein the template is made from polyethene or polypropylene.

6. The method according to claim 1, wherein the template is made from aluminum oxide.

7. The method according to claim 1, wherein the support plate is made from a metal.

8. The method according to claim 1, wherein attaching the support plate comprises gluing the plate to the template and to the graphene fibers.

9. The method according to claim 8, wherein gluing the plate to the template and to the graphene fibers comprises using an epoxy-based glue.

10. The method according to claim 1, further comprising arranging a mould around the template, the mould comprising solid walls to contain the polymer material.

11. The method according to claim 1, wherein arranging the graphene fibers through the openings comprises stitching of the fibers.

12. The method according to claim 1, further comprising braiding and/or twisting the graphene fibers before arranging them in the openings.

13. The method according to claim 1, further comprising attaching support plates on two opposing sides of the template.

14. A thermal interface film comprising:
a plurality of area portions consisting of polymer-infiltrated graphene fibers, wherein the extension of the graphene fibers are in a direction perpendicular to the plane of the film; and
wherein the plurality of area portions of polymer-infiltrated graphene fibers are surrounded by a polymer material.

15. The thermal interface film according to claim 14, wherein the film has a thermal conductivity in a direction perpendicular to the plane of the film in the range of 10 W/mK to 200 W/mK.

16. The thermal interface film according to claim 14, wherein the amount of graphene fibers in the thermal interface film is in the range of 5 vol % to 90 vol %.

17. The thermal interface film according to claim 14, wherein the polymer-infiltrated graphene fibers comprise continuous graphene fibers reaching from a top surface of the thermal interface film to a bottom surface of the thermal interface film.

18. The thermal interface film according to claim 14, wherein the polymer-infiltrated graphene fibers comprise braided graphene fibers.

19. The thermal interface film according to claim 14, wherein the polymer-infiltrated graphene fibers comprise twisted graphene fibers.

20. The thermal interface film according to claim 14, wherein the polymer-infiltrated graphene fibers comprise graphene fibers reinforced by graphene flakes.
